(19) United States
(12) Patent Application Publication
(10) Pub. No.: US 2016/0048305 A1
(43) Pub. Date: Feb. 18, 2016

(54) Group-Based User Interface Rearrangement

(71) Applicant: Microsoft Corporation, Redmond, WA (US)

(72) Inventors: Poorva Singal, Redmond, WA (US); Jeff G. Arnold, Sammamish, WA (US); Christopher Milan Raykovich, Seattle, WA (US); John C. Whytock, Portland, OR (US); John P. Aronson, Seattle, WA (US); Peter J. Kreiseder, Redmond, OR (US); Andres Antonio Toussaint, Sammamish, WA (US)

(21) Appl. No.: 14/459,826

(22) Filed: Aug. 14, 2014

(51) Int. Cl. G06F 3/0484; G06F 3/0481

(52) U.S. Cl. CPC G06F 3/04845; G06F 3/04847; G06F 3/04842; G06F 3/04817

(57) ABSTRACT

Group-based user interface rearrangement techniques are described. In one or more embodiments, a display manager module is configured to output a user interface for display via a display device. The user interface is configured to present an arrangement of graphics in groups in which the graphics visually represent and enable selectable access to underlying content items. The display manager module is configured to detect input indicative of a rotation of the display device. The display manager module may also detect other display-change events, such as changing the display device that is used to output the user interface. In response to detection of such events, the display manager module determines a rearrangement of the graphics that corresponds to the particular event.

### BACKGROUND

Computing devices have been developed to increase the settings in which computing functionality is made available to users. Mobile phones, for example, have evolved from having just basic telephone functionality to having the ability to run applications. Tablet computing devices have also been developed to provide users with increased access to computing functionality in a mobile setting. By way of example, mobile phones and tablets may enable users to check email, surf the web, compose texts, interact with applications, and so on in a variety of mobile settings. Both mobile phones and tablets are configured to be held by a user during interaction.

Because users hold these mobile devices, a user may be able to easily change a mobile device's orientation during interaction. For example, a user may hold a mobile device vertically for some interactions and horizontally for others. Mobile devices may also support functionality that allows a user to resize user interface windows, e.g., so that more windows can be viewed via the user interface or so that a particular window can be enlarged relative to the display. Consequently, many mobile devices have been configured to adjust a user interface displayed thereon to correspond to a current orientation of the mobile device and actions performed by a user that affect display of the user interface. Conventional techniques for adjusting user interfaces may be applicable to limited configurations of user interfaces (e.g., paginated configurations), however. Further, conventional techniques may, for user interfaces configured in some ways, disrupt an arrangement of graphic items displayed on the user interface. For example, the graphic items may be rearranged in a manner that is not intuitive to a user given a previous arrangement. Consequently, adjustment of such user interfaces using conventional techniques can lead to user confusion.

### SUMMARY

Group-based user interface rearrangement techniques are described. In one or more embodiments, a display manager module, executable via a processing system of a computing device, is configured to output a user interface for display via a display device. The user interface is configured to present an arrangement of graphics that visually represent and enable selectable access to underlying content items. For example, the user interface may present the arrangement of graphics in groups having pre-defined size constraints (e.g., to limit a width of each group). The pre-defined size constraints may be imposed on the groups regardless of an orientation of the display device.

In one or more embodiments, the display manager module is configured to detect input indicative of a rotation of the display device. The display manager module may also detect other display-change events, such as changing the display device used to output the user interface. In response to detection of such events, the display manager module may determine a rearrangement of the graphics that corresponds to the particular event. When input indicative of a rotation of the display device is detected, for instance, the display manager module may determine a rearrangement that is configured to maintain the groups and reposition the graphics contained within the groups to correspond to the rotation.

The rearrangement may also be configured to reposition the graphics contained within the groups so that the graphics of a particular group are presented in a same pattern as in the arrangement. Relative to the graphics of another group, however, the graphics of the particular group may have a different alignment than in the arrangement. In one or more embodiments, the rearrangement may be configured instead to maintain an orientation of the graphics contained within the particular group relative to the graphics contained within another group. In this case, the rearrangement may also be configured to reposition the visually represented underlying content of the graphics to correspond to the detected display-change event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2 is an illustration of an example implementation showing a change in orientation of a display device and a corresponding rearrangement of graphics that are presented in a user interface.

FIG. 3 is an illustration of an example implementation showing the change in orientation of the display device and a corresponding rearrangement of graphics that are presented in a user interface having different arrangement constraints than the user interface of FIG. 2.

FIG. 4 is an illustration of an example implementation showing the change in orientation of the display device and a corresponding rearrangement of graphics that is different than the rearrangement described with reference to FIG. 3.

FIG. 5 is an illustration of an example implementation showing a change of a display device to which a user interface is output and a corresponding rearrangement of graphics that are presented in the user interface.

FIG. 6 is a flow diagram depicting a procedure in an example implementation in which the graphics of a user interface are rearranged according to one technique.

FIG. 7 is a flow diagram depicting a procedure in an example implementation in which the graphics of the user interface are rearranged according to another technique.

FIG. 8 is a flow diagram depicting a procedure in an example implementation in which the graphics of the user interface are rearranged according to another technique than in FIGS. 6 and 7.

FIG. 9 illustrates an example system including various components of an example device in accordance with one or more embodiments.

### DETAILED DESCRIPTION

Overview

User interfaces may be configured in a variety of ways to present graphics that visually represent and enable selectable access to underlying content items. For example, a user interface may be configured to have multiple pages of graphics (e.g., icons, tiles, and so on) that each have a same number of locations in which to position graphics of substantially a same size. Such a user interface may be referred to as a “paginated” user interface. Alternately, a user interface may be configured as a single page of graphics that appears to extend beyond the boundaries of a display device via which the user interface is displayed. A viewing pane, through which graphics positioned in a portion of the user interface are viewable at a time, may enable a user to scroll through the user interface to view graphics positioned in other portions. This type of user interface may be referred to as a “continuously-scrolling” user interface.

Regardless of configuration, the manner in which a user interface is adjusted to accommodate changes to the display device (e.g., rotation of the device or switch to display on a different device) can impact its usability. Consider an example in which rotation of a display device causes graphics of the user interface to be adjusted in a way that is not immediately intuitive to a user. After such an adjustment, the user may spend more time locating a particular graphic of interest than if the graphics had been rearranged in a manner that was intuitive to the user. Although conventional techniques for adjusting user interfaces may be applicable to some user interface configurations (e.g., paginated configurations), such techniques may not be applicable to others (e.g., continuously-scrolling configurations, configurations in which graphics are arranged in user-customized groups, configurations that allow graphics of variable sizes, and so on). Further, conventional techniques may simply fail to adjust graphics arranged on a user interface in an intuitive manner to accommodate changes to the display device.

Group-based user interface rearrangement techniques are described. The techniques may include support for rearranging graphic representations (e.g., tiles), that function as intermediaries within a root level (e.g., a start screen) of a file system, in an intuitive manner. For example, the root level may include graphic representations, such as tiles of applications, within a start menu that a user can arrange into groups.

When a change is detected to the display device via which the user interface is output, the techniques described herein may rearrange the graphic representations (“graphics”) in a way that not only corresponds to the change, but also preserves the user-customized groups.

Consider an example in which the graphics of a continuously-scrolling user interface are implemented as tiles and in which a user can arrange the tiles into groups. In this particular example, pre-defined size limits of the groups may restrict a width of each group but not a height. Given such limits, the user may arrange tiles in a particular group to extend in a horizontal direction as far as the width limit and indefinitely in a vertical direction.

When a user interface configured in this way is output via a display device held in a landscape orientation, the width constraints may enable multiple groups of the graphics to be displayed side-by-side. When the orientation is then changed so that the display device is held in a portrait orientation, however, the same groups that were displayed side-by-side in the landscape orientation may not be able to fit side-by-side in the portrait orientation. Using the techniques described herein, a group that was located to the side of another group, but that no longer fits side-by-side in the display with that other group, may be repositioned underneath it. In other words, groups that were positioned side-by-side may be rearranged so that they are instead stacked on one another.

Consider a different example in which the graphics of a user interface can be arranged into groups but in which the pre-defined size constraints limit both a width and a height of each group. The pre-defined size constraints may limit the groups of graphics to being square-shaped, for example. In this example, it may be that two such groups (e.g., a first group and a second group) can fit side-by-side in a landscape orientation of the display device, such that the first group is located on a left side of the display and the second group is located on the right side of the display. When the orientation of the display device is rotated in a clockwise direction by ninety degrees to a portrait orientation, and before any rearrangement is performed, the first group is located on a top of the display and the second group on the bottom. Both groups nevertheless still fit in the display. To reorient any text and images displayed via the graphics, each group may be rotated by ninety degrees in a counterclockwise direction around an axis that runs through a center of the group in a direction that is substantially perpendicular to a display surface of the display device.

Using the techniques described herein the graphics may be arranged in other ways for a user interface configured as in the different example. For instance, the orientation of the display device may, from a landscape orientation, be rotated in a clockwise direction by ninety degrees to a portrait orientation. Accordingly, before any rearrangement is performed, the first group is located on top of the display and the second group on the bottom, and both groups still fit in the display. Instead of rotating each group by ninety degrees, the techniques described herein may rotate the content in each graphic by ninety degrees in a counterclockwise direction. For a graphic that is not square-shaped, the content may be resized and/or cropped to fit therein.

The group-based user interface rearrangement techniques described herein may also be applied when display-change events other than rotation of a display device are detected. For example, these techniques support rearrangement of a user interface when it is detected that the user interface is to be output to a different display device (e.g., a projector) or that a display resolution of the display device is to be changed.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

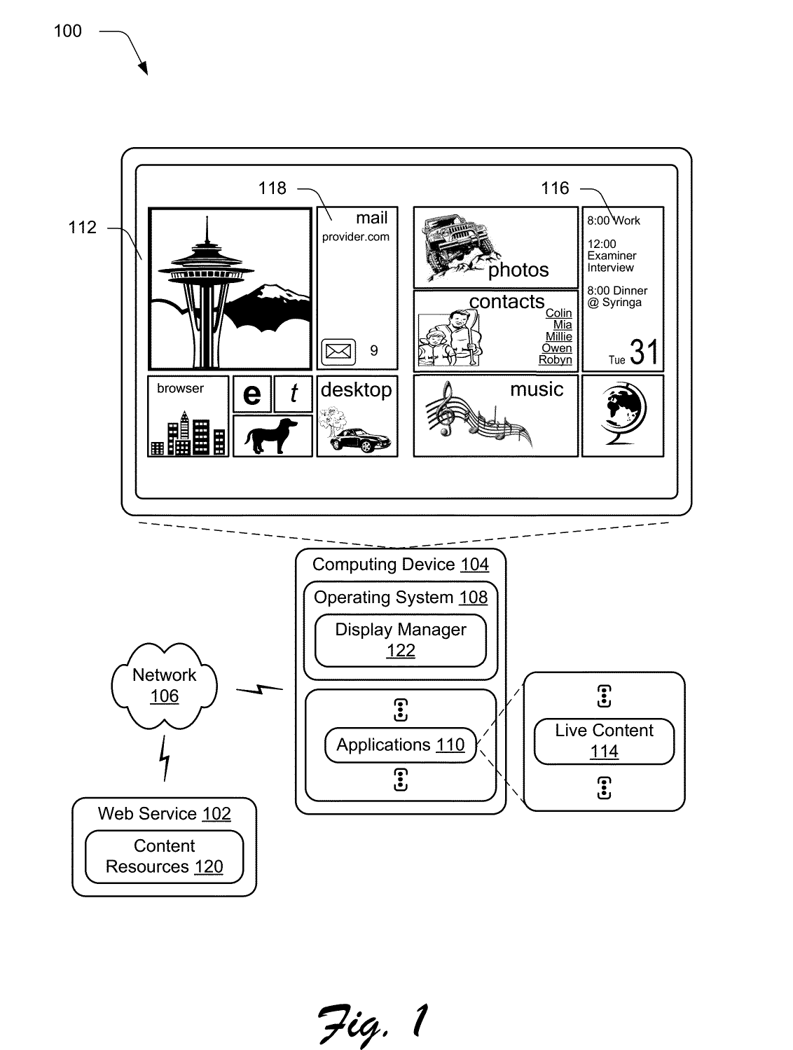

FIG. 1 is an illustration of an environment 100 in an example implementation that is operable to employ the group-based user interface rearrangement techniques described herein. The illustrated environment 100 includes a web service 102 and a computing device 104 that are communicatively coupled via a network 106. The web service 102 and the computing device 104 may be implemented by a wide range of computing devices.

For example, a computing device may be configured as a computer that is capable of communicating over the network 106, such as a desktop computer, a mobile station, an entertainment appliance, a set-top box communicatively coupled to a display device, a mobile communication device, a game console, a slate computer (e.g., a tablet as illustrated for the computing device 104), and so forth. Thus, a computing device may range from full resource devices with substantial memory and processor resources (e.g., personal computers, game consoles) to a low-resource device with limited memory and/or processing resources (e.g., traditional set-top boxes, hand-held game consoles). Additionally, a computing device may be representative of a plurality of different devices, such as multiple servers utilized by a business to perform operations, a remote control and set-top box combination, an image capture device and a game console configured to capture gestures, and so on.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The computing device 104 is further illustrated as including an operating system 108. The operating system 108 is configured to abstract underlying functionality of the computing device 104 to applications 110 that are executable on the computing device 104. For example, the operating system 108 may abstract processing, memory, network, and/or display functionality of the computing device 104 such that the applications 110 may be written without knowing “how” this underlying functionality is implemented. The application 110, for instance, may provide data to the operating system 108 to be rendered and displayed by the display device 112 without understanding how this rendering will be performed.

The operating system 108 may also represent a variety of other functionality, such as to manage a file system and a user interface that is navigable by a user of the computing device 104. An example of this is illustrated as an application launcher (e.g., start screen) that is displayed on the display device 112 of the computing device 104. The start screen includes graphic representations (“graphics”) that are selectable to provide access to underlying content items, such as a plurality of the applications 110. The graphics may be implemented as icons, tiles, textual descriptions, and so on which may be displayed in a matrix or grid of rows and/or columns of graphics (icons, tiles, etc.) that represent applications. The start screen may be considered a root level of a hierarchical file structure, e.g., each of the other levels are “beneath” the root level in the hierarchy. At least some of the graphics shown in the illustrated example are selectable to launch a corresponding one of applications 110 for execution on the computing device 104. In this way, a user may readily navigate through a file structure and initiate execution of applications of interest.

In one or more embodiments, content configured to update periodically may be displayed as part of the graphics for the applications. The content displayed on a graphic may be updated at pre-determined intervals and/or responsive to an update event (e.g., breaking news), for example. Due to this updating, the content displayed via the graphics can be referred to as “live content”.

The live content 114 represents the content that is displayed via the graphics and that is configured to be updated. Graphic 116, for instance, may represent a calendar application. Graphic 116 is illustrated as including content that indicates a schedule for the current day, e.g., “8:00 Work, 12:00 Examiner Interview, and 8:00 Dinner@Syringa” for “Tue 31”. Likewise, a graphic 118 for an email application indicates that a current number of unread email messages is “9”. The live content 114 that is displayed via the graphics may be updated based on content updates received from the web service 102. The web service 102 is illustrated as including content resources 120, which represent content that can be delivered to the computing device 104 and configured as the live content 114 to populate the graphics. By way of example, the web service 102 may provide a social network service and the content resources 120 may be updates for the users of the social network. Data from the content resources 120, such as updates pertaining to a user associated with the computing device 104, can be delivered to the computing device and configured as the live content 114. As the social network updates are received, the corresponding live content 114 can be presented on a graphic corresponding to the social network service (not shown).

In this way, a user may readily view information relating to the applications 110 without having to launch and navigate through each of the applications. Although graphics of specific applications are shown, other graphics of applications are also contemplated, such as a graphic of an application that references a user's involvement with a service, e.g., a friend of the user in the social network service. Another graphic may be utilized to allow a user provide limited inputs to an application and/or allow limited functionality to application features such as making a call, answering a text, post a status, play a video or song, etc. Another application graphic at a root level mode may include a full functionality implementation of the app within the larger root mode display, such as a calculator, Sudoku game, video player.

The operating system 108 is also illustrated as including a display manager module 122 (“display manager 122”). The display manager 122 is representative of functionality to manage rearrangement of graphics (e.g., icons, tiles, and so on) that are included as part of a user interface output via a display device in response to display-change events, such as a rotation of the display device 112, a change to the display resolution of the display device 112, or a change to output the user interface on a different display device (not shown), and so forth.

The display manager 122 may also be representative of functionality to manage customization of the arrangement of graphics presented via the user interface. As part of doing so, the display manager 122 may impose constraints on the customizations that a user is allowed to make to the arrangement. For example, the display manager 122 may specify that the graphics are to be arranged in groups, such that each graphic is contained within a region of the user interface designated for the corresponding group. For each such group, the display manager 122 may impose pre-defined size constraints, e.g., to restrict a width or a height of each group. By way of example, the display manager 122 may restrict a height and width of each group based on a smallest dimension of the display device 112. By restricting the groups in this way, the display manager 112 may ensure that a row of groups can fit on the display when positioned in a landscape orientation or that a column of groups can fit on the display when positioned in a portrait orientation.

The display manager 122 may also impose other constraints on the arrangements and the individual groups. For a user interface that includes graphics configured as tiles, for instance, the display manager 122 may restrict a user to customizations of the tiles (e.g., positioning or repositioning of a tile, sizing or resizing of a tile, and so on) that follow a grid arrangement. By way of example, and not limitation, the display manager 122 may also restrict a user interface to having a pre-defined number of groups, restrict each of the groups to having a pre-defined number of graphics, specify spacing between the groups, specify particular locations at which the graphics can be located on the user interface, restrict the size of each graphic, and so on.

In addition, the display manager 122 may impose constraints on functionality of the user interface associated with its display. With a continuously-scrolling user interface, for instance, the display manager 122 may enable a user to scroll continuously across the user interface in a vertical direction, but prohibit scrolling in a horizontal direction, e.g., when the display device 112 is positioned in a portrait orientation and the graphics are arranged in a column. Alternately, the display manager 122 may enable a user to scroll continuously across the user interface in a horizontal direction, but prohibit scrolling a vertical direction, e.g., when the display device 112 is positioned in a landscape orientation and the graphics are arranged in a row. In some embodiments, the display manager 122 may enable a user to scroll continuously across the user interface in both the horizontal and vertical direction until a boundary of the user interface is reached, e.g., beyond which there are no more graphics. With a paginated user interface, the display manager 122 simply may not allow scrolling. Instead, the display manager 122 may enable a user to switch from one page of the user interface to another.

The display manager 122 also represents functionality to determine priorities for the graphics and the groups. The display manager 122 may do so based, at least in part, on where a user positions a graphic or group within the user interface. Within a particular group, for instance, the display manager 122 may determine that graphics positioned in the upper left of the group have a highest priority and that graphics positioned in the bottom right of the group have a lowest priority.

By way of example, the display manager 122 may assign priorities to the graphics in a group radially. To do so, the display manager 122 may assign a highest priority to graphics that are positioned within a first radius centered at the upper-left corner of the group. The display manager 122 may assign a next highest priority to the graphics positioned within a second radius (larger than the first radius), a third highest priority to the graphics positioned within a third radius (larger than the second radius), and so on. It should be appreciated that priorities may be radially assigned to graphics using more or fewer radii than the three discussed in the preceding example. It should also be appreciated that priorities may be radially assigned to graphics of a group using radii centered at different location of the group, e.g., at a determined center of the group.

The display manager 122 may assign priorities to the groups in a similar manner as to the graphics within a particular group. For example, the display manager 122 may determine that groups positioned in the upper-left of the user interface have a highest priority and that groups positioned in the bottom-right have a lowest priority. Like with the graphics, the display manager 122 may do so radially. By way of example, the display manager 122 may assign a highest priority to the group or groups that are positioned within a first radius centered at the upper-left corner of the user interface, a next highest priority to groups positioned within a second radius (larger than the first radius), and so on. Alternately, priorities may be radially assigned to groups using radii centered at some other location of the user interface, e.g., its determined center.

Priorities for the graphics and the groups may also be determined in other ways without departing from the spirit and the scope of the techniques described herein. For example, the priorities may be determined based on usage. The graphics that are selected more often to access the underlying content (e.g., application), or that are interacted with more often (e.g., when the graphic itself provides functionality), may be determined to have a higher priority than those that are accessed or interacted with less often. Coincidentally, the groups having the most accessed and interacted-with applications may be determined to have a higher priority than the groups having less accessed and interacted-with applications.

Returning to the discussion of the capability of the display manager 122 to rearrange graphics of a user interface responsive to detection of a display-change event. The display manager 122 may rearrange the graphics of the user interface both to correspond to the detected display-change event and based on any arrangement constraints, arrangement frameworks, and/or determined priorities of the graphics. Other criteria may be considered by the display manager 122 to rearrange the graphics without departing from the scope of the techniques describe herein.

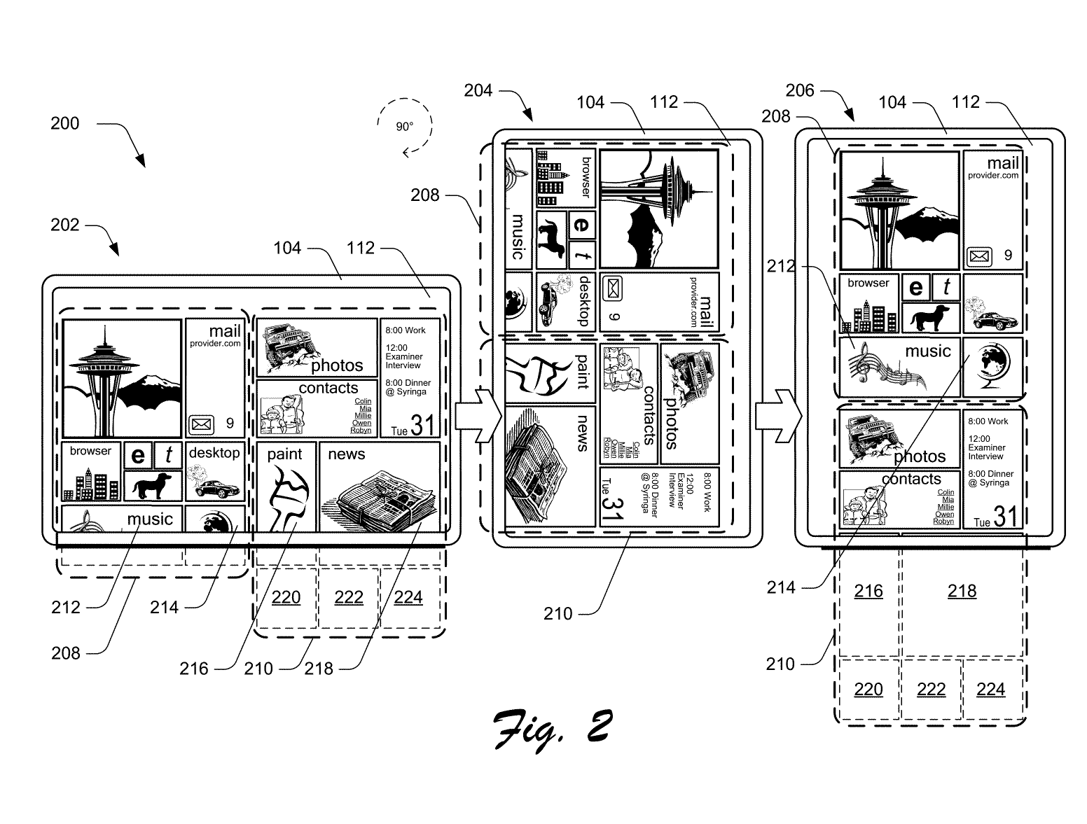

FIG. 2 depicts an implementation showing an example at 200 in which an orientation of the display device 112 of FIG. 1 is changed and a corresponding rearrangement of the graphics included in the user interface is performed. The example illustrated at 200 depicts the computing device 104 of FIG. 1 initially in a landscape orientation at 202. FIG. 2 also depicts, at 204, the computing device 104 of FIG. 1 having its orientation changed to a portrait orientation (e.g., by rotating the computing device ninety degrees clockwise from the orientation depicted at 202), but before the graphics are rearranged. At 206, the computing device 104 is depicted with the graphics having been rearranged according to one or more embodiments.

It should be appreciated that a rearrangement of the graphics may be performed at a time other than after a complete ninety-degree rotation to a different orientation. By way of example and not limitation, the graphics may be rearranged when it is detected that the computing device 104 is rotated at least a threshold amount (e.g., thirty degrees or forty-five degrees) toward a different orientation. Alternately or in addition, the graphics may be rearranged responsive to detection of a rapid change in rotation as measured by an accelerometer or other device of the computing device. It should also be appreciated that performing a rearrangement of the graphics is not limited to the clockwise rotation of the computing device that is illustrated. The graphics may also be rearranged, for instance, when the computing device is rotated in a counterclockwise direction.

With reference to the landscape orientation depicted at 202, the user interface output via the display device 112 is depicted presenting portions of a first group 208 and a second group 210 of graphics. The portion of the user interface that is presented on the display device 112 may be considered that which is viewable though a viewing pane. By scrolling the viewing pane (e.g., responsive to scrolling navigation inputs), other portions of the user interface may be viewable though the viewing pane.

By way of example, the portions of the first group 208 and the second group 210 that are viewable through the viewing pane (and thus presented via the display device) include less than an entirety of graphics 212, 214, 216, 218. These graphics 212, 214, 216, 218 extend beyond the portion of the user interface that is viewable through the viewing pane. Responsive to navigation inputs to scroll in a downward direction, however, the viewing pane may be shifted to display the undisplayed portions of the graphics 212, 214, 216, 218. Undisplayed graphics 220, 222, 224 are also depicted in FIG. 2, and can also be made viewable responsive to navigation inputs to scroll the viewing pane in a downward direction. To display the undisplayed graphics 220, 222, 224 though, a user may have to scroll down further than was needed to display the undisplayed portions of the graphics 212, 214, 216, 218.

The arrangements of graphics in FIG. 2 also represents a scenario in which the display manager 122 imposes pre-defined size constraints on the graphic arrangement. In particular, FIG. 2 represents a scenario in which the display manager 122 restricts the width but not a height of the groups. The display manager 122 may impose such constraints regardless of an orientation of the display device 112. In FIG. 2, for instance, the group width restriction is applied to the arrangement of graphics with the display device 112 positioned in both a landscape orientation (e.g., as at 202) and a portrait orientation (e.g., as at 206). Although the arrangement of graphics depicted at 204 may not comply with the width restriction, the user interface may be displayed in this way just until the display manager 122 detects the change in orientation (to portrait) and causes the graphics to be rearranged and rendered.

To represent these constraints, that restrict a width but not a height of the groups, the first group 208 and the second group 210 are depicted each having a substantially same width but different heights, e.g., the second group 210 has the undisplayed graphics 220, 222, 224, which make up an additional row of graphics. The width constraint may restrict a user to arranging the graphics of a group (or the display manager 122 when rearranging the graphics) into patterns in which the arranged graphics do not span a greater horizontal distance than that defined by the constraint. Although the groups depicted in FIG. 2 are not restricted by a height constraint, a height constraint may be imposed in one or more embodiments in a similar manner to the width constraint. In other words, a height constraint may restrict a user to arranging the graphics of a group (or the display manager 122 when rearranging the graphics) into patterns in which the arranged graphics do not span a greater vertical distance than that defined by the constraint. Regardless of whether the graphics are being arranged by a user or rearranged by the display manager 122, predefined width and height constraints dictate bounds within which a group's graphics are to be contained.

Given the arrangement constraints represented in FIG. 2, the display manager 122 may rearrange the graphics of the user interface in the following way when a switch from the landscape orientation to the portrait orientation is detected. Due to its positioning in the landscape orientation at 202 as the left-most group, the first group 208 may be determined the highest priority group. The second group 210, because it is positioned next to the highest priority group, may be the group with the next highest priority. If a third group were arranged just below the first group 208 in the landscape orientation at 202, then that third group may be determined to have higher priority than the second group 210, but such a determination would depend on how priority is determined. Assuming though that the first group 208 has a highest priority and the second group 210 a next highest priority, the display manager 122 can rearrange the graphics so that the first group 208 is repositioned at a top of the user interface (e.g., because it has the highest priority) and the second group 210 just below the first group 208, as at 206. At 206, the graphics of each group have also been rotated from the way presented at 204 by ninety degrees in a counterclockwise direction.

Given this and a downward shift of the second group 210, an entirety of the first group 208 may be presented as a result of the rearrangement, such as at 206. Note that graphics 212, 214 in particular, which were just partially displayed in the arrangement corresponding to the landscape orientation at 202, are completely displayed in the rearrangement corresponding to the portrait orientation depicted at 206. In contrast, a smaller portion of the graphics of the second group 210 are displayed at 206. Consider graphics 216, 218 in particular, which at 202 are almost fully on-screen, but at 206 are almost fully off-screen.

By repositioning graphics as depicted in FIG. 2, the resulting rearrangement may be intuitive to a user. The graphics that a user specifically positions in the upper-left of a particular user interface arrangement can also be positioned in the upper-left of a rearrangement determined by the display manager 122. As discussed with reference to determining priorities, it may be that the highest priority graphics are positioned in a location of the user interface other than the upper-left, e.g., the center. Accordingly, the graphics may be rearranged by the display manager 122 so that the highest priority graphics and groups remain, in a rearrangement, in substantially a same location as in the arrangement.

In one or more embodiments, the display manager 122 may track the orientation (e.g., landscape or portrait) at which the display device 112 was positioned when user inputs were last received to customize the arrangement of graphics. For example, if the display device 112 was positioned in a landscape orientation when user input was last received to arrange (e.g., reposition or resize) the graphics of the user interface, information indicating this may be maintained. Consequently, rather than determining a rearrangement when the display device 112 is rotated from portrait to landscape, the display manager 122 may simply restore the user-customized arrangement of icons for the landscape orientation to be displayed.

Similarly, if the display device was positioned in a portrait orientation when user input was last received to arrange the graphics of the user interface, information indicating this may be maintained. In this case, rather than determining a rearrangement when the display device is rotated from landscape to portrait, the display manager 122 may simply restore the user customized arrangement of icons for the portrait orientation to be displayed. To present the user-customized arrangement, information indicative of that arrangement may be maintained at the computing device 104.

In a similar manner, a user may supply an input that indicates to restore a particular arrangement of graphics whenever the display device 112 is positioned a particular orientation. The display manager 122 may cause information indicative of the particular arrangement to be maintained at the computing device 104, and the particular arrangement to be restored when the display device 112 is positioned in the particular orientation. Alternately or in addition, the display manager 122 may track groups that are visible via the display device 112 prior to an orientation change. When performing a rearrangement of the graphics, the display manager 122 may use this information to rearrange the graphics so that the groups that were visible prior to the orientation change remain visible on the display device 112 after the orientation change.

Although FIG. 2 illustrates a rearrangement of graphics for a rotation from the landscape orientation at 202 to the portrait orientation at 206, it should be appreciated that the display manager 122 can also determine a rearrangement of graphics from the portrait orientation at 206 to the landscape orientation at 202. By way of example, the display manager 122 may cause graphics that were arranged on the user interface as depicted at 206 to be rearranged into the pattern depicted at 202.

FIG. 2 is just one example of the constraints that can be imposed on user interface arrangements and functionality. The display manager 122 may be configured to impose different constraints on the arrangement of graphics and on the functionality without departing from the scope of the techniques described herein. By way of example and not limitation, a pre-defined width constraint may allow for three groups to be presented side-by-side in a landscape orientation rather than just two, a pre-defined width constraint may allow for multiple groups to be presented side-by-side in a portrait orientation rather than just one, pre-defined size constraints may limit group height but not width such that multiple groups can be presented top-to-bottom in the portrait orientation and enable a user to scroll horizontally to view undisplayed portions of the groups, and so forth.

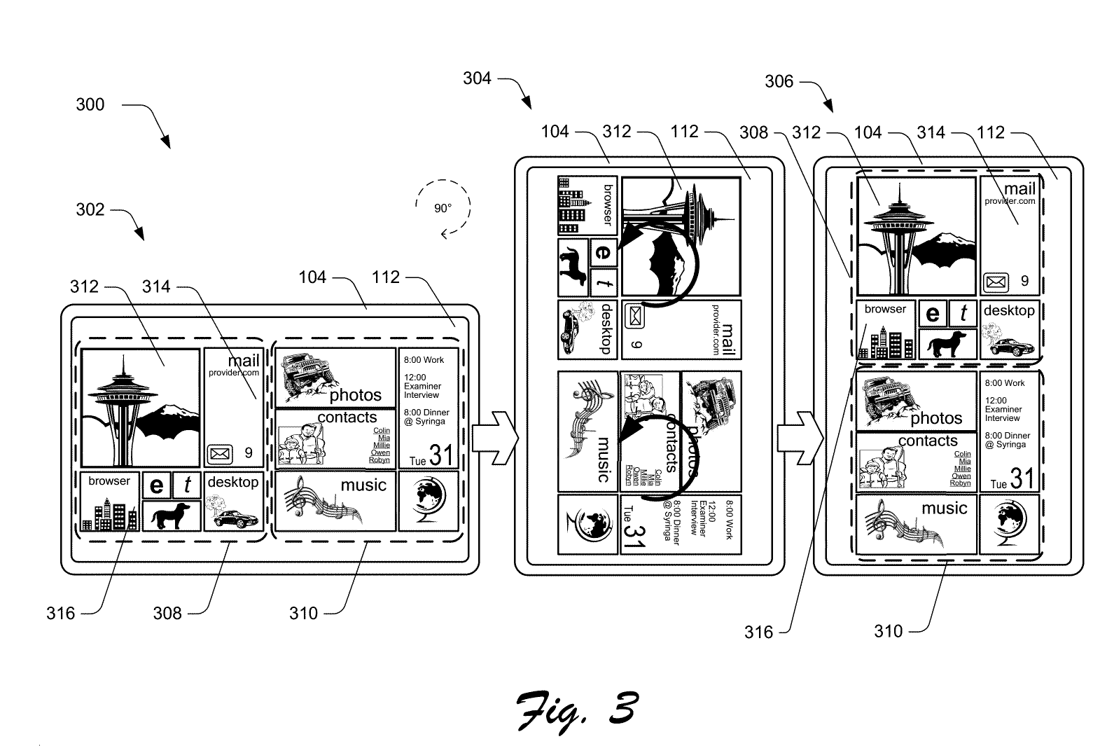

FIG. 3 depicts an implementation showing an example at 300 in which an orientation of the display device 112 of FIG. 1 is changed and a corresponding rearrangement of the graphics included in the user interface is performed. However, FIG. 3 represents a scenario in which different constraints are imposed on the arrangement of the groups.

In particular, FIG. 3 represents a scenario in which both the width and the height are restricted by pre-defined size constraints imposed by the display manager 122. In the illustrated example at 300 the width and height of the groups are substantially equal. However, the width and height of the groups may be constrained in other ways (e.g., so that the width and height are not substantially equal) in accordance with the techniques described herein when both vertical and horizontal scrolling across the user interface are enabled. The example illustrated at 300 depicts the computing device 104 initially positioned in a landscape orientation at 302. At 304, the computing device 104 is depicted having had its orientation changed to a portrait orientation (e.g., by a ninety-degree clockwise rotation), but before the graphics are rearranged. At 306, the computing device 104 is depicted with the graphics having been rearranged according to one or more embodiments.

With reference to the landscape orientation depicted at 302, the user interface output via the display device 112 is depicted presenting a first group 308 and second group 310 of graphics. The pre-defined height and width constraints represented by this scenario may result in the first group 308 and the second group 310 being substantially square-shaped. As a result, an entirety of the first group 308 and the second group 310 may be viewable both in a landscape orientation (e.g., as at 302) and in a portrait orientation (e.g., as at 306).

From the landscape orientation depicted at 302, the display device 112 may be rotated ninety degrees in the clockwise direction to temporarily result in the user interface being displayed as at 304. The user interface may be displayed in this way for the portrait orientation just until the display manager 122 detects the change in orientation and causes the graphics to be rearranged and rendered. By way of example, the display manager 122 may determine to rearrange the graphics by rotating each group as a group ninety degrees counterclockwise around an axis that runs through a center of the group in a direction substantially perpendicular to a display surface of the display device 112. For embodiments in which a width and height of the groups are not substantially equal, the display manager 122 may determine axes around which to rotate the groups and rearrange the graphics by rotating each group as a group around a respective determined axis. Further, the display manager 122 may reposition the groups so that the graphics of one group do not overlap those of another group.

As a result of the rearrangement, the first group 308 is stacked on top of the second group 310 at 306 rather than being aligned side-by-side. In other words, the rearrangement rotates the groups into different alignment with respect to one another relative to alignment of the groups in the arrangement. In the illustrated example, an alignment of the groups, one to another, has changed from a side-to-side alignment to a top-to-bottom alignment.

An order in which the groups are stacked may be based on prioritization of the groups. By way of example, a group with the highest priority may be arranged at a top of the stack of groups, a group with the second highest priority below the highest-priority group, and so on. The display manager 122 may determine a priority of the groups based on a defined algorithm to determine which groups are displayed closer to a top of the stack. It should also be appreciated that when the groups are arranged side-to-side, an order in which the groups are arranged from left to right may be based on the prioritization of the groups, such that the group with the highest priority is arranged at the left of the user interface, the group with the next highest priority arranged to the right and next to the highest priority group, and so on.

Although an alignment of the groups in FIG. 3 has changed, one group to another, from a side-to-side alignment to a top-to-bottom alignment, the relative positioning of the graphics contained within the groups has been maintained. Graphic 312, for instance, is positioned to the left of graphic 314 in both the arrangement corresponding to the landscape orientation depicted at 302 and the rearrangement corresponding to the portrait orientation depicted at 306. Further, graphic 312 is positioned directly above graphic 316 in both the arrangement and rearrangement. In this way, the display manager 122 repositions the graphics to correspond to the change of the display device 112 (e.g., by a rotation in an opposite direction as the display device is rotated) but presents the graphics of a particular group in a same pattern in the arrangement and rearrangement.

Although FIG. 3 illustrates a rearrangement of graphics for a rotation of the display device 112 from the landscape orientation at 302 to the portrait orientation at 306, it should be appreciated that the display manager 122 can also determine a rearrangement of graphics for a rotation of the display device 112 from the portrait orientation at 306 to the landscape orientation at 302. By way of example, the display manager 122 may cause graphics that were arranged on the user interface as depicted at 306 to be rearranged into the pattern depicted at 302.

In an example in which the user interface is paginated, the display manager 122 may impose constraints so that each page of the user interface has a same number of graphics (e.g., icons) arranged horizontally and vertically. Responsive to an orientation change, like that described above with reference to FIG. 3, the display manager 122 may be configured to rotate the items of the page, as a group, to correspond to the orientation change.

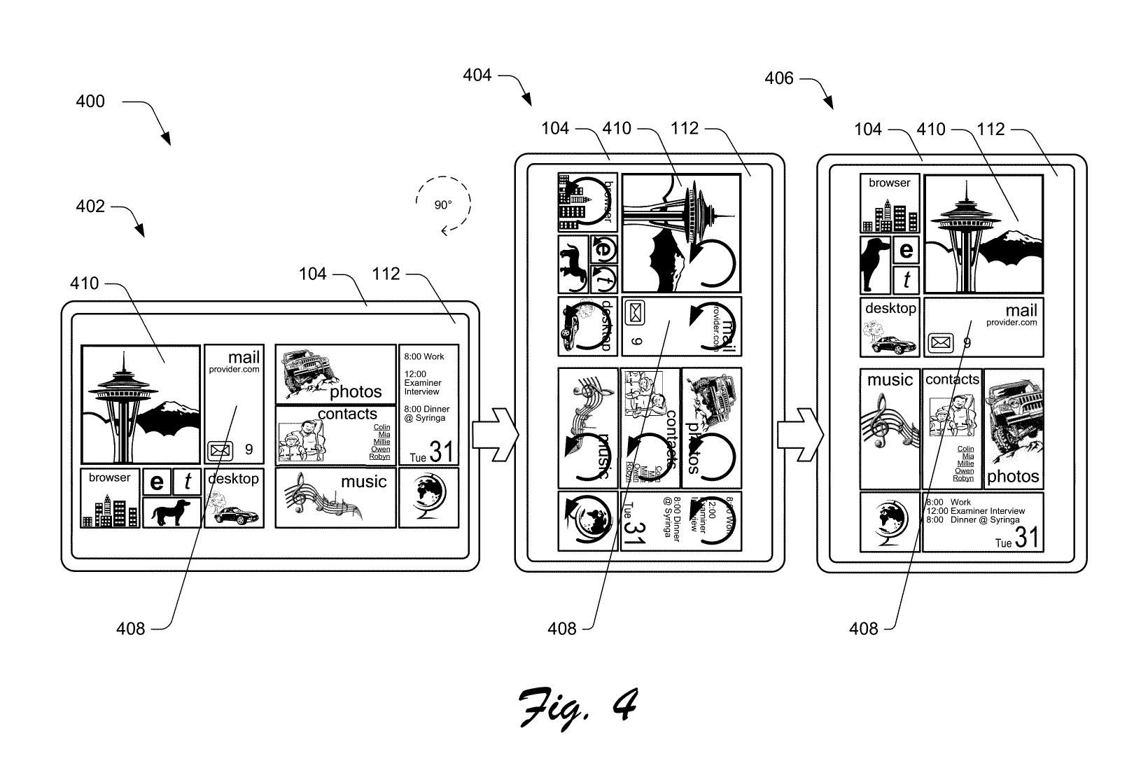

FIG. 4 depicts an implementation showing an example at 400 in which the orientation of the display device 112 is changed and in which the same constraints are imposed on the group arrangements as in FIG. 3, but in which the graphics are rearranged in a different manner from FIG. 3. The example illustrated at 400 depicts the computing device 104 initially positioned in a landscape orientation at 402, having had its orientation changed to a portrait orientation at 404, and with the graphics having been rearranged at 406.

The rearrangement of graphics illustrated in FIG. 4 is different from that illustrated in FIG. 3 insofar as the groups of graphics in FIG. 4 are not rotated and repositioned, as a group. Consider graphic 408, as a particular example. At 404, a size of graphic 408 is approximately one unit high by two units wide. At 406, the graphic 408 is the same size, e.g., one unit high by two units wide. This same observation is applicable to each of the graphics depicted in the user interface at 404 and at 406. In other words, the pattern in which the graphics are arranged is not changed between 404 and 406.

Instead, the content depicted on each graphic is repositioned. For square graphics such as graphic 410 the content depicted thereon can simply be rotated to correspond to the orientation change, e.g., from the position depicted at 404 to the position depicted at 406. For non-square graphics such as graphic 408, however, mere rotation may not be sufficient to fit the depicted content on the graphic. Rather, the display manager 122 may rearrange or replace the content of the graphic to correspond to the orientation change. By way of example and not limitation, the display manager 122 may do so by moving portions of a graphic's content to different locations, adjusting a cropping of content, changing font sizes, excluding some of the content presented for a previous orientation, adding content that was not displayed for a previous orientation, replacing the content with other content, and so on.

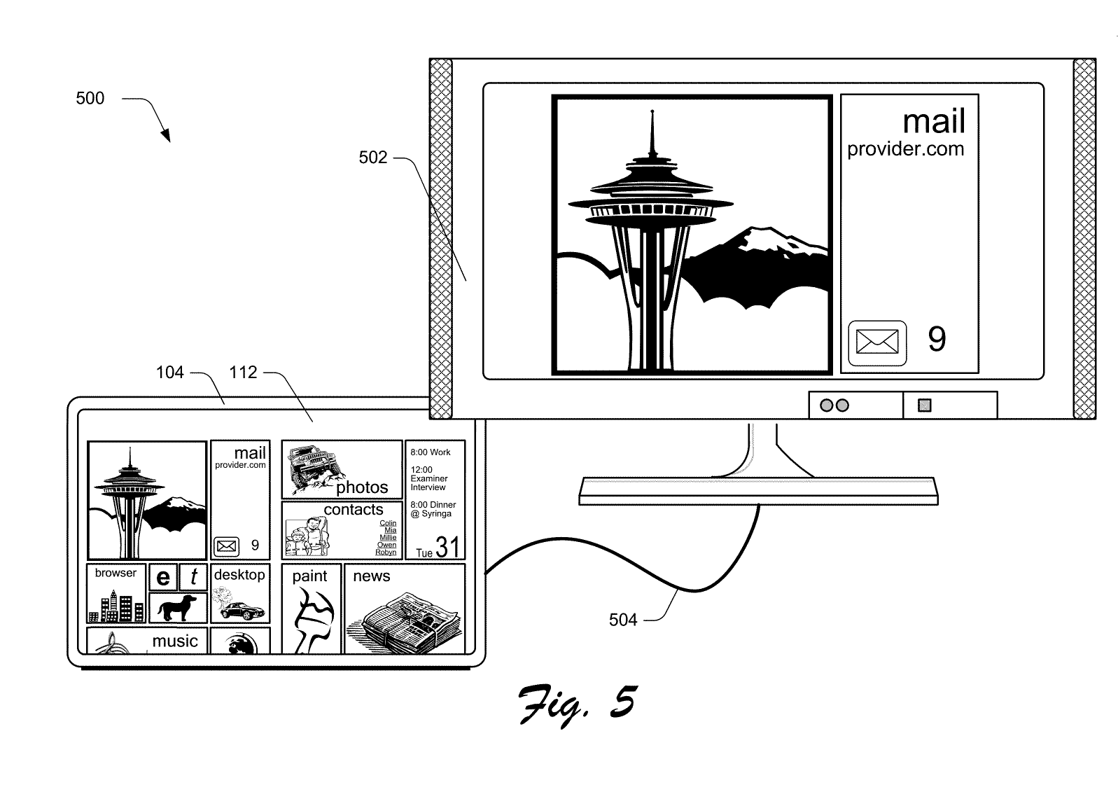

FIG. 5 depicts an implementation showing an example at 500 in which a display device via which a user interface is output is changed. Further, FIG. 5 depicts presenting a rearrangement of graphics that corresponds to the change of the display device. The illustrated example 500 includes the computing device 104 with display device 112 and additional display device 502.

FIG. 5 also represents a scenario in which the additional display device 502 is connected to the computing device 104. Although a wired connection is illustrated, the connection 504 between the computing device 104 and the additional display device 502 may be formed in other ways, such as wirelessly. The connection 504 may enable the display manager 122 to cause the user interface to be presented on the additional display device 502. Accordingly, the display manager 122 may manage the display of the user interface presented via the additional display device 502, e.g., by updating the graphics, enabling scrolling to other portions of the user interface, and so on.

In any case, the forming of the connection 504 to display the user interface on the additional display device 502 may be detected by the display manager 122. This event, as well as the rotations described with reference to FIGS. 2-4, may each be referred to as a “display-change event”. When these events occur, the way in which the user interface is displayed may be changed so that it is more easily comprehended by a user (as in the case of the rotations), or so that it can simply be displayed via a different display device. Without departing from the spirit of the techniques described herein, events in addition to rotations of a display device and changes to different display devices may be considered “display-change events” detectable by the display manager 122, and responsive to which graphics of a user interface are rearranged.

The illustrated example at 500 represents a scenario in which the additional display device 502 has a different display resolution than that of the display device 112. Consequently, the user interface may not be displayable on the additional display device 502 at a same resolution as on the display device 112. To enable display of the user interface on the additional display device 502, the display manager 122 may rearrange the graphics so that the user interface can be displayed at the resolution of the additional display device.

For example, the graphics may be rearranged as depicted so that fewer (or a smaller portion of) graphics at a time are viewable than on the display device 112. For a display device having a greater resolution, the display manager 122 may rearrange the graphics so that a greater number of graphics (or a larger portion of the user interface) is viewable at a time. In conjunction with determining a rearrangement, the display manager 122 may ascertain the display capabilities of a display device and base the rearrangement on those capabilities. The display manager 122 may rearrange a user interface to accommodate a change to a display device in a variety of ways without departing from the techniques described herein.

In addition to determining rearrangements for various display change events and user interfaces subject to various pre-defined arrangement constraints, display manager 122 may also be configured to determine animations to transition from the arrangement of the graphics to the rearrangement. By way of example, and not limitation, the animations that can be applied to the transitions may include fade ins and fade outs, animation of a rotation in an opposite direction that a display device was rotated, sliding of groups to different positions on a user interface, sliding of graphics to different positions on the user interface, rotating and/or sliding of content, and so forth. Other animations may be applied to the transitions without departing from the scope of the techniques described herein.

Having considered the foregoing example operating environment, devices, and device architecture, consider now some example procedures in accordance with one or more embodiments.

Example Procedures

The following discussion describes group-based user interface rearrangement techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

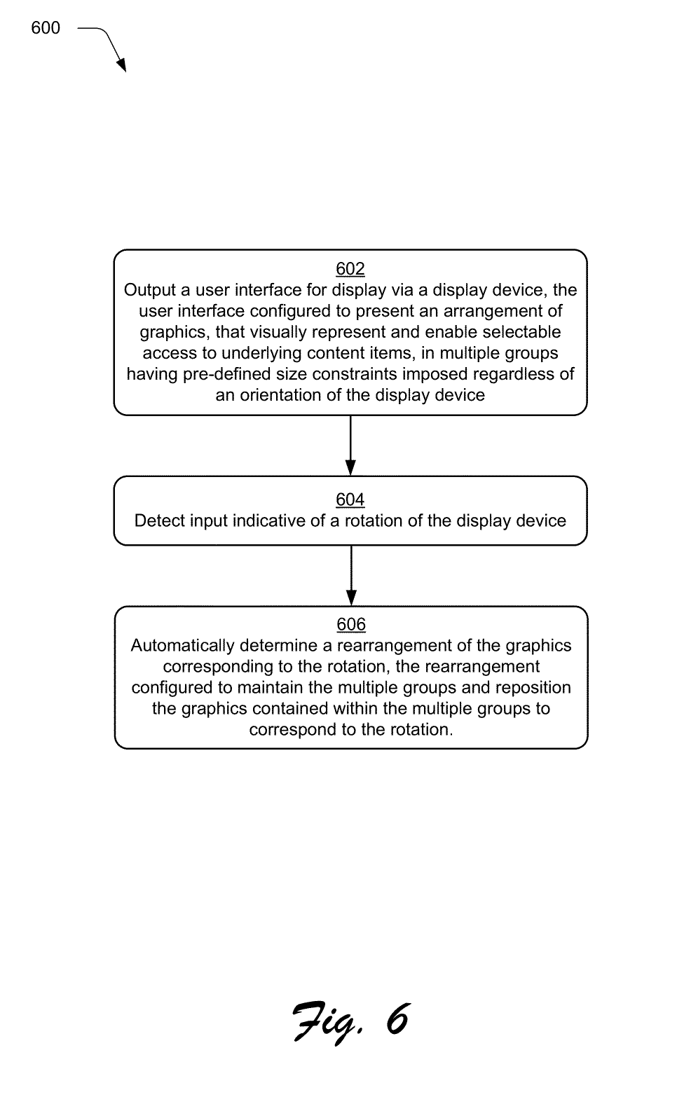

FIG. 6 depicts a procedure 600 in an example implementation in which the graphics of a user interface are rearranged according to one technique. A user interface configured to present an arrangement of graphics that visually represent and enable selectable access to underlying content items is output for display via a display device (block 602). The user interface is also configured to enable arrangement of the graphics into one or more groups that have pre-defined size constraints imposed regardless of an orientation of the display device.

For example, the display manager 122 may cause the user interface that is depicted in FIG. 2 at 202 to be output via the display device. As previously described, the graphics of this user interface are arranged into at least a first group 208 and a second group 210. Further, the display manager 122 may impose pre-defined size constraints on the first group 208 and the second group 210 that limit the width of each group. The width of the first group 208 and the second group 210 is limited both when the display device 112 is positioned in a landscape orientation as depicted at 202 and in a portrait orientation as depicted at 206.

An input indicative of a rotation of the display device is detected (block 604). For example, sensors of the computing device 104 sense that the computing device has been rotated from the landscape orientation depicted at 202 to the portrait orientation depicted at 204. The sensors that sense this change may include an accelerometer, a gyroscope, an image sensor (e.g., a camera), and so on. Regardless of the type of sensor, the display manager 122 may detect input indicative of such change via one or more of the sensors.

Responsive to detection of the input, a rearrangement of the graphics corresponding to the rotation is automatically determined (block 606). The automatically determined rearrangement is configured to maintain the one or more groups and reposition the graphics contained within the one or more groups to correspond to the rotation.

With reference again to FIG. 2, the display manager 122 determines the arrangement of graphics depicted at 206. The display manager 122 may, as is the case in FIG. 2, rotate the first group 208 ninety degrees in the counterclockwise direction around an axis that runs substantially through a center of the group. The display manager 122 may also rotate the second group 210 in a similar manner. The display manager 122 may also reposition the groups so that the first group 208 is positioned at a top of the viewable portion of the user interface and the second group 210 is positioned just below the first group 208. Such a rearrangement may be determined for the rotation depicted in FIG. 2 due in part to the arrangement constraints imposed by the display manager 122. For other rotations of the display device 112, the display manager 122 may determine other rearrangements that correspond to rotation, e.g., depending on where highest priority graphics are to be positioned, usage data, and so on.

After the rearrangement is determined, the display manager 122 causes rendering of the user interface to present the rearrangement of the graphics via the display device 112.

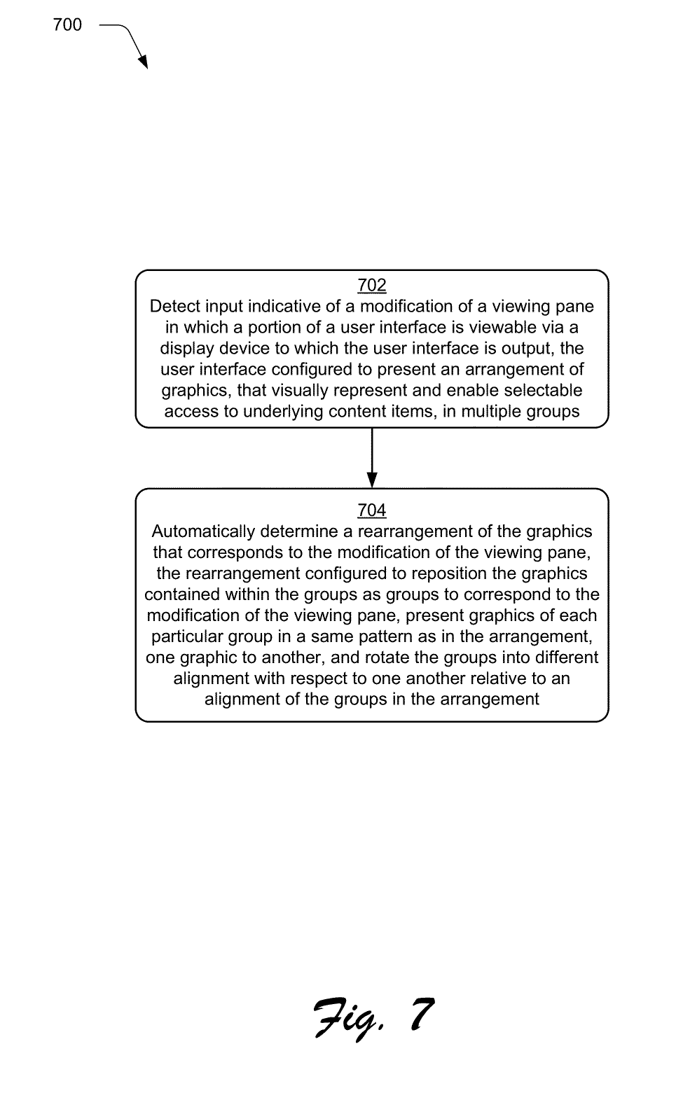

FIG. 7 depicts a procedure 700 in an example implementation in which the graphics of a user interface are rearranged according to another rearrangement technique. Input is detected that is indicative of modification of a viewing pane in which a portion of a user interface is viewable via a display device to which the user interface is output (block 702). The user interface is configured to present an arrangement of graphics in one or more groups in which each graphic may visually represent and enable selectable access to underlying content items.

For example, the display manager 122 may detect modification of the viewing pane through which the portion of the interface depicted in FIG. 3 at 302 is output, such as in response to the orientation of the display device having been changed as at 304. The graphics depicted as part of this user interface may when selected allow access to the content represented by the graphics, e.g., an application and the functionality thereof. Some of the graphics may also allow access to the functionality without being selected to “open” the underlying application. Instead, the functionality may be accessible via the graphic at the user interface level.

Responsive to detecting the input at block 702, a rearrangement of graphics is automatically determined that corresponds to the modification of the viewing pane (block 704). The rearrangement may be configured to reposition the graphics contained within the groups as groups to correspond to the modification of the viewing pane. The rearrangement may also be configured to present the graphics of each particular group in a same pattern as in the arrangement, one graphic to another. Further, the rearrangement may be configured to rotate the groups into different alignment with respect to one another relative to an alignment of the groups in the arrangement.

For example, the display manager 122 determines the arrangement of graphics depicted at 306 for the rotation of the display device 112 from the orientation depicted at 302 to the orientation depicted at 304. The rearrangement determined by the display manager 122 may be determined in part based on the pre-defined constraints imposed on arrangement of the groups, e.g., the height and width constraints imposed on the arrangements in FIG. 3. The rearrangement depicted at 306 may reposition the graphics contained within the groups as groups to correspond to the rotation of the display device 112, e.g., by rotating the groups ninety degrees in the counterclockwise direction.

Due to the rotation of each group individually, the graphics of a particular group may be presented in the rearrangement in a same pattern as in the arrangement, one graphic to another. Take the first group 308, for example, which appears the same both at 302 and 306. In other words, the graphics of the first group 308 have a same pattern relative to one another in both the landscape orientation depicted at 302 and the portrait orientation depicted at 306. However, the graphics of the first group 308 have a different alignment relative to the graphics of the second group 310 in the rearrangement (e.g., top-to-bottom) and the arrangement (e.g., side-to-side).

After the rearrangement is determined, the display manager 122 causes rendering of the user interface to present the rearrangement of the graphics via the display device 112.

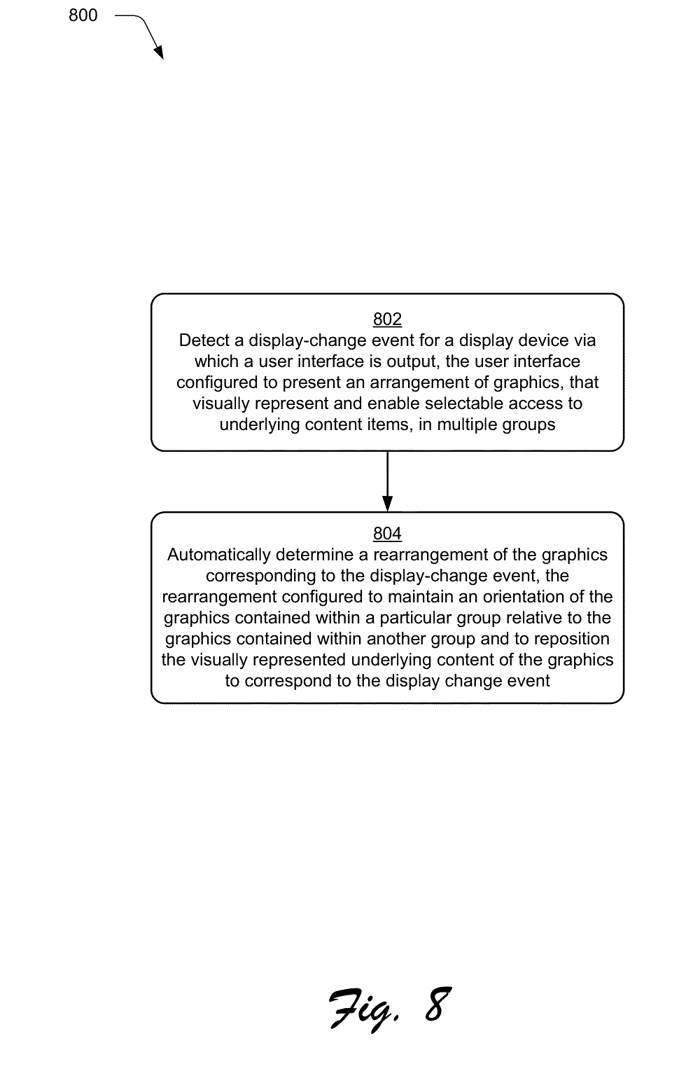

FIG. 8 depicts a procedure 800 in an example implementation in which the graphics of a user interface are arranged according to another technique than in FIGS. 6 and 7. A display-change event is detected for a display device via which a user interface is output (block 802). The user interface is configured to present an arrangement of graphics in groups in which graphics visually represent and enable selectable access to underlying content items. For example, the display manager 122 detects a display-change event that corresponds to rotation of the display device from the orientation depicted at 402 to the orientation depicted at 404.

After the display-change event is detected, a rearrangement of the graphics is determined that corresponds to the display change event (block 804). The rearrangement is configured to maintain an orientation of the graphics contained within a particular group relative to the graphics contained within another group. Additionally, the rearrangement is configured to reposition visually represented underlying content of the graphics to correspond to the display change event.

For example, the display manager 122 determines the rearrangement of graphics depicted at 406. The rearrangement determined by the display manager 122 may maintain an orientation of the graphics contained within the particular groups relative to the graphics contained within the other groups, e.g., by maintaining an orientation of each graphic such as graphic 408. Instead, the display manager 122 rotates the content within the graphic 408 to correspond to the rotation of the display device 112 from the orientation depicted at 402 to the orientation depicted at 404, 406.

Having considered the foregoing example procedures, consider now an example system and device in accordance with one or more embodiments.

Example System and Device

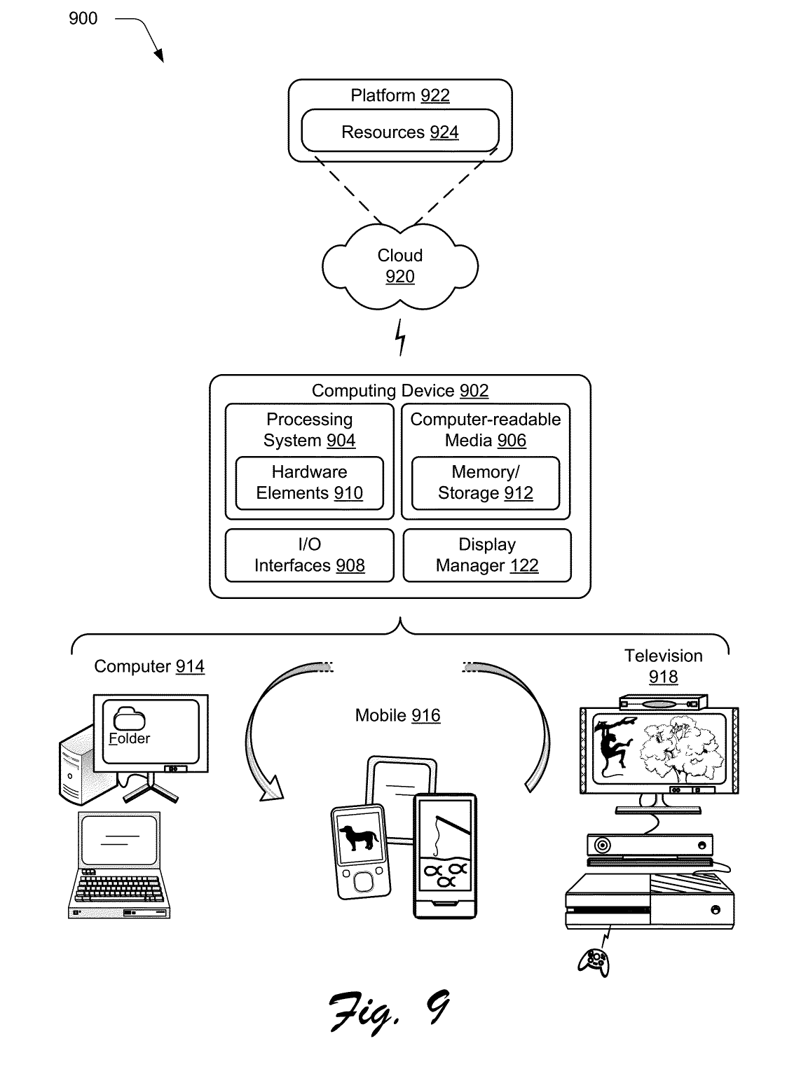

FIG. 9 illustrates an example system generally at 900 that includes an example computing device 902 that is representative of one or more computing systems and/or devices that may implement the various techniques described herein, which is illustrated through inclusion of the display manager 122. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Conclusion

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
a processing system; and
a display manager module executable via the processing system to:
output a user interface for display via a display device, the user interface configured to present an arrangement of graphics, that visually represent and enable selectable access to underlying content items, in one or more groups having pre-defined size constraints imposed regardless of an orientation of the display device;
detect input indicative of a rotation of the display device; and
responsive to detection of the input, automatically determine a rearrangement of the graphics corresponding to the rotation, the rearrangement configured to maintain the one or more groups and reposition the graphics contained within the one or more groups to correspond to the rotation.

2. A computing device as described in claim 1, wherein the display manager module is further executable to cause rendering of the user interface by the processing system to present the rearrangement of the graphics via the display device.

3. A computing device as described in claim 1, wherein the pre-defined size constraints limit a width of each of the one or more groups.

4. A computing device as described in claim 1, wherein the pre-defined size constraints do not limit a width of each of the one or more groups.

5. A computing device as described in claim 1, wherein the pre-defined size constraints do not limit a height of each of the one or more groups.

6. A computing device as described in claim 1, wherein the pre-defined size constraints limit a height of each of the one or more groups.

7. A computing device as described in claim 1, wherein the display manager module is further executable to determine priorities of the graphics based on positions of the graphics relative to the other graphics in the arrangement and the graphics are repositioned in the rearrangement based in part on the determined priorities.

8. A computing device as described in claim 1, wherein the arrangement of the graphics is defined for an orientation of the display device relative to which user input was last received to arrange the graphics within the groups.

9. A computing device as described in claim 8, wherein the user input that was last received to arrange the graphics within the groups comprises at least one of input to position the graphics within the groups or resize the graphics within the groups.

10. A computing device as described in claim 8, wherein the orientation relative to which the user input was last received to position the graphics within the groups comprises one of a portrait orientation or a landscape orientation of the display device.

11. A computing device as described in claim 10, wherein the rearrangement of the graphics is determined for whichever of the portrait orientation or the landscape orientation was not the last orientation relative to which the user input was last received to position the graphics within the groups.

12. A computing device as described in claim 1, wherein the display manager module is further executable to:
detect an additional input indicative of another rotation of the display device, the other rotation rotating the display device back to an orientation from which the rotation rotated the display device; and
responsive to detection of the additional input, reposition the graphics from the rearrangement of the graphics to present the graphics according to the arrangement of the graphics.

13. A computing device as described in claim 1, wherein the graphics are implemented as tiles that follow a grid arrangement and the arrangement and the rearrangement of the graphics are configured to follow the grid arrangement.

14. A computing device as described in claim 1, wherein the display manager module is further executable to:
detect input indicative of a change to the display device via which the user interface is output;
responsive to detection of the input indicative of the change, automatically determine another rearrangement corresponding to the change of the display device, the other rearrangement configured to maintain the one or more groups and reposition the graphics within the one or more groups to correspond to the change of the display device; and
cause rendering of the user interface by the processing system to present the other rearrangement of the graphics via the changed display device.

15. A computer-implemented method comprising:
detecting input indicative of a modification of a viewing pane in which a portion of a user interface is viewable via a display device to which the user interface is output, the user interface configured to present an arrangement of graphics, that visually represent and enable selectable access to underlying content items, in one or more groups; and
responsive to detection of the input, automatically determining a rearrangement of the graphics that corresponds to the modification of the viewing pane, the rearrangement configured to:
reposition the graphics contained within the groups as groups to correspond to the modification of the viewing pane,
present graphics of each particular group in a same pattern as in the arrangement, one graphic to another; and
rotate the groups into different alignment with respect to one another relative to alignment of the groups in the arrangement.

16. A method as described in claim 15, further comprising causing rendering of an animation to transition from presentation of the arrangement to present the rearrangement of the graphics via the display device.

17. A method as described in claim 15, wherein the user interface is configured to enable continuous scrolling in at least one of a horizontal or vertical direction to cause other portions of the user interface to be viewable via the viewing pane.

18. A method as described in claim 15, wherein the modification of the viewing pane corresponds to at least one of a rotation of the viewing pane or a change of the display device to which the user interface is output.

19. A computer-implemented method comprising:
detecting a display-change event for a display device via which a user interface is output, the user interface configured to present an arrangement of graphics, that visually represent and enable selectable access to underlying content items, in one or more groups;
responsive to detection of the input, automatically determining a rearrangement of the graphics corresponding to the display-change event, the rearrangement configured to maintain an orientation of the graphics contained within a particular group relative to the graphics contained within another group and to reposition the visually represented underlying content of the graphics to correspond to the display-change event; and
causing rendering of the user interface to present the rearrangement of the graphics via the display device.

20. A method as described in claim 19, wherein the display-change event is detected responsive to at least one of a rotation of the display device or a change of the display device used to output the user interface.
